(19) United States
(12) Patent Application Publication
(10) Pub. No.: US 2024/0288300 A1
(43) Pub. Date: Aug. 29, 2024

(54) SCALE MANAGEMENT SYSTEM AND METHOD

(71) Applicant: TruckPay Inc., Tenafly, NJ (US)

(72) Inventor: Barry Scott Honig, Tenafly, NJ (US)

(73) Assignee: TruckPay Inc., Tenafly, NJ (US)

(21) Appl. No.: 18/585,032

(22) Filed: Feb. 22, 2024

Related U.S. Application Data
(63) Continuation-in-part of application No. 17/888,765, filed on Aug. 16, 2022.
Application No. 17/888,765 is a continuation of application No. 17/673,057, filed on Feb. 16, 2022, now Pat. No. 11,448,546.
Application No. 17/673,057 is a continuation-in-part of application No. 16/839,768, filed on Apr. 3, 2020, now Pat. No. 11,287,304.
Application No. 16/839,768 is a continuation of application No. 16/451,482, filed on Jun. 25, 2019, now Pat. No. 10,634,547.
(60) Provisional application No. 62/862,800, filed on Jun. 18, 2019.

(51) Int. Cl. G01G 19/02; G06Q 20/18; G06Q 30/018; G06Q 30/02; G06Q 50/18

(52) U.S. Cl. CPC G01G 19/02; G06Q 20/18; G06Q 30/018; G06Q 30/0281; G06Q 50/18

(57) ABSTRACT

A scale management system is disclosed that is configured to initiate a weighment workflow for cargo including one or more units carried by a first vehicle, generate a virtual scale configured to obtain scale data from a physical scale that includes a scale designed to weigh individual cargo units, the virtual scale including a software representation of the physical scale, wherein hardware specifications of the physical scale are defined via the virtual scale, generate a virtual kiosk corresponding to the virtual scale that is configured for use during weighments of the one or more units in the cargo on the physical scale, and generate a master weigh ticket from the virtual kiosk including weighment data for the cargo, the weighment data including first weighment data for the one or more units in the cargo and second weighment data for a total weighment of the cargo by the physical scale.

### CROSS REFERENCE TO RELATED APPLICATIONS

This application is a continuation-in-part of U.S. patent application Ser. No. 17/888,765 filed on Aug. 16, 2022, entitled “Truck Scale Management System And Method,” which is a continuation of U.S. patent application Ser. No. 17/673,057 filed on Feb. 16, 2022 (now U.S. Pat. No. 11,448,546 issued on Sep. 20, 2022), entitled “Truck Scale Management System And Method,” which is a continuation-in-part of U.S. patent application Ser. No. 16/839,768 filed on Apr. 3, 2020 (now U.S. Pat. No. 11,287,304 issued on Mar. 29, 2022), entitled “Truck Scale Management System And Method,” which is a continuation of U.S. patent application Ser. No. 16/451,482 filed on Jun. 25, 2019 (now U.S. Pat. No. 10,634,547 issued on Apr. 28, 2020), entitled “Truck Scale Management System And Method,” which claims the priority of U.S. Provisional Application No. 62/862,800, entitled “Truck Scale Management System And Method,” filed on Jun. 18, 2019, the disclosures of which are hereby incorporated by reference in their entirety.

This application is also related to U.S. patent application Ser. No. 18/219,493 filed on Jul. 7, 2023, entitled “Truck Scale Payment System And Method,” the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This application relates to electronic scales for weighment of one or more units of cargo, and in particular, to scales with customizable web-based kiosk interfaces.

Scales designed to weigh cargo are well known in the art. Scales can be used to check individual and gross cargo weights to determine the weight of a load or amount of goods being transported. Scales can also be used to check whether the vehicle transporting the cargo is safe to travel on public roads or bridges without being stopped and fined by the authorities for being overloaded. By weighing individual units of cargo and aggregating all weighments, the load carried by the vehicle can be calculated. Scales are used in industries that manufacture or move bulk items, such as in mines or quarries, garbage dumps or recycling centers, as well as for movement of bulk liquid and powder, household goods, and electrical equipment. Scales are a quick and easy way to measure the flow of bulk goods in and out of different locations.

Kiosk systems may be used with scales to manage the flow of vehicles in and out of sites, such as a plant or facility. Kiosk devices can either be mounted inside a scale house or outside on a post or pedestal near the scale. The kiosk system may facilitate vehicle identification, capturing vehicle weight, and loading on site. A kiosk may comprise a data collection system that is designed specifically for those sites. As such, these kiosks can integrate with a facility's central office and accounting systems.

However, existing kiosk systems lack ease and versatility for upgrades and features that can be customized without the need of servicing technicians. There is thus a need for a scale kiosk system with improved scalability and customization for scale owners and drivers.

### SUMMARY

A new scale management system is disclosed. The system comprises a processor coupled to memory, in which the processor is configured to initiate a weighment workflow for cargo carried by a first vehicle. The cargo comprises one or more units. The processor is further configured to generate a virtual scale configured to obtain scale data from a physical scale. The physical scale comprises a scale designed to weigh individual cargo units and the virtual scale comprises a software representation of the physical scale. Hardware specifications of the physical scale are defined via the virtual scale. The processor is further configured to generate a virtual kiosk corresponding to the virtual scale. The virtual kiosk is configured for use during weighments of the one or more units in the cargo on the physical scale. The processor is further configured to generate a master weigh ticket from the virtual kiosk comprising weighment data for the cargo. The weighment data comprises first weighment data for the one or more units in the cargo and second weighment data for a total weighment of the cargo by the physical scale.

The physical scale may comprise a platform or bucket scale. The virtual kiosk may be configured for access by a user on a mobile device. The processor may be further configured to edit the virtual scale and the virtual kiosk based at least in part on a user selection of a physical scale. The processor may be further configured to filter available scales based at least in part on a user selection of a physical scale.

The processor may be further configured to set a default scale based at least in part on a user selection of a default scale, and to generate the virtual scale and the virtual kiosk based at least in part on the set default scale.

The total weighment data of the cargo may comprise a total gross weight and a total net weight. The master weigh ticket may further comprise a weigh ticket number, a start date, a start time, an end date, an end time, an indication that the master weigh ticket is void, a void date, a void time, and information identifying a voiding user. The processor may be further configured to generate a sub-weigh ticket from the virtual kiosk, the sub-weigh ticket comprising weighment data for a unit of cargo by the physical scale.

A method is also disclosed herein executed by a hardware processor that in some embodiments comprises initiating a weighment workflow for cargo carried by a first vehicle. The cargo comprises one or more units. The method further comprises generating a virtual scale configured to obtain scale data from a physical scale. The physical scale comprises a scale designed to weigh individual cargo units. The method further comprises generating a virtual kiosk corresponding to the virtual scale. The virtual kiosk is configured for use during weighments of the one or more units in the cargo on the physical scale. The method further comprises generating a master weigh ticket from the virtual kiosk comprising weighment data for the cargo. The weighment data comprises first weighment data for the one or more units in the cargo and second weighment data for a total weighment of the cargo by the physical scale.

The physical scale may comprise a platform or bucket scale. The virtual kiosk may be configured for access by a user on a mobile device. The processor may be further configured to edit the virtual scale and the virtual kiosk based at least in part on a user selection of a physical scale. The processor may be further configured to filter available scales based at least in part on a user selection of a physical scale, and to set a default scale based at least in part on a user selection of a default scale.

The total weighment data of the cargo may comprise a total gross weight and a total net weight. The master weigh ticket may further comprise a weigh ticket number, a start date, a start time, an end date, an end time, an indication that the master weigh ticket is void, a void date, a void time, and information identifying a voiding user. The processor may be further configured to generate a sub-weigh ticket from the virtual kiosk, the sub-weigh ticket comprising weighment data for a unit of cargo by the physical scale.

In an embodiment, a non-transitory computer readable medium is disclosed that comprises instructions that, when executed by at least one processor, cause the at least one processor to initiate a weighment workflow for cargo carried by a first vehicle. The cargo comprises one or more units. The processor is further configured to generate a virtual scale configured to obtain scale data from a physical scale. The physical scale comprises a scale designed to weigh individual cargo units. The processor is further configured to generate a virtual kiosk corresponding to the virtual scale. The virtual kiosk is configured for use during weighments of the one or more units in the cargo on the physical scale. The processor is further configured to generate a master weigh ticket from the virtual kiosk comprising weighment data for the cargo. The weighment data comprises first weighment data for the one or more units in the cargo and second weighment data for a total weighment of the cargo by the physical scale.

The foregoing summary is illustrative only and is not intended to be in any way limiting. These and other illustrative embodiments include, without limitation, apparatus, systems, methods and computer-readable storage media. In addition to the illustrative aspects, embodiments, and features described above, further aspects, embodiments, and features will become apparent by reference to the drawings and the following detailed description.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a computing system according to an embodiment of the present invention.

FIG. 2 illustrates a data flow diagram of a scale management system according to an embodiment of the present invention.

FIG. 3 presents a data flow diagram of a scale management system according to an embodiment of the present invention.

FIG. 4 presents another data flow diagram of a scale management system according to an embodiment of the present invention.

FIGS. 5 through 7 illustrate exemplary screen interfaces for configuring virtual scales and kiosks in a scale management system according to an embodiment of the present invention.

FIG. 8 illustrates a tablet kiosk device according to an embodiment of the present invention.

FIG. 9 presents a process according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present application discloses a scale management system that provides web-accessible kiosk interfaces to scales. The scale management system may include a platform for creating and editing virtual kiosks that associate functionalities and workflow with physical scales. A virtual kiosk may comprise software associated with a scale for logistics, weighing method (e.g., tare then gross weight (“TG”), gross then tare weight (“GT”), tare weight only (“TO”), or gross weight only (“GO”), re-weighment), payments, and billing that can be customized to meet the need of a specific customer by defining entries in specific tables in a database.

The platform may allow customers to specify the type of data that they want their software-defined kiosks to collect and how they want to subsequently access that data for further analysis. A given virtual kiosk may be associated with a particular scale or a scale management system. Additionally, multiple virtual kiosks, that perform different functions, may also be connected to the same scale. In some embodiments, multiple scales may be allowed to share the functionality of multiple virtual kiosks. The disclosed system is also applicable to any scale that streams a weight over an electronic indicator, such as a food scale in a food processing factory, etc., and where the information from the scale is recorded electronically along with other related information.

The platform may include a web interface that provides scale owners with administrative capabilities to create and modify virtual scales and associated kiosks. Scale-owners and trucking companies, as well as drivers, may create accounts and view weighment reports. In one embodiment, client devices such as smart phones may be used by users to connect to and interact with scales. A security layer may be established where users can login to use particular scales.

The disclosed system may increase flexibility with re-provisioning, adding, or expanding kiosk/scale features. The system's device and location independence enables users to access a kiosk and scale using a web application or browser regardless of their location or what device they use (e.g., PC, mobile device). As kiosk and scale interfaces are off-site and accessed via a network, such as the Internet, users can connect to the kiosk and scale from anywhere. As such, the presently disclosed system provides flexibility of being able to change the virtual kiosk in real-time and being able to attach any number of virtual kiosks to a given scale at a time.

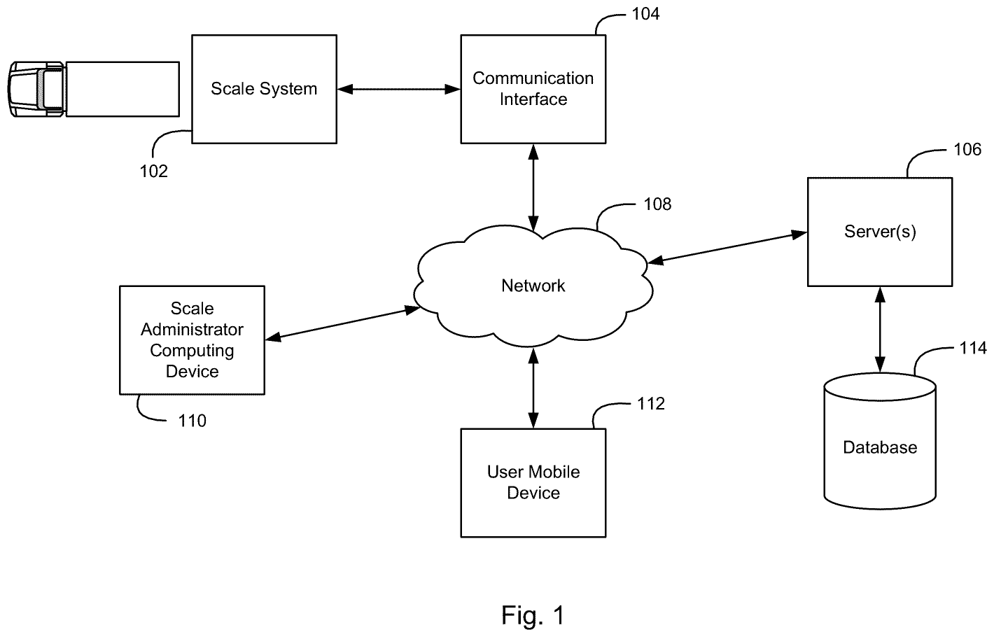

FIG. 1 illustrates a computing system according to an embodiment of the present invention. The system presented in FIG. 1 includes scale system 102, communication interface 104, server(s) 106, network 108, scale administrator computing device 110, and user mobile device 112. Scale system 102 may comprise structures and devices that are integrated with a weighing apparatus that can measure a weight of a unit of cargo such as boxes or buckets of loose material. Exemplary weighing apparatuses of the disclosed system include platform scales, floor scales, deck scales, hanging scales, crane scales, and bucket scales. The weighing apparatuses of the disclosed system can, for example, weigh individual cargo units and can hold up to 5,000 pounds. In some embodiments, the weighing apparatus comprises a truck scale. The scale system 102 may include electronic components such as a load cell including a transducer that converts an analog signal into a digital weight readout.

The scale system 102 may be configured with or connected to a communication interface 104. Scale management system comprising server(s) 106 may connect to communication interface 104 to establish communications over network 108. The communication interface 104 may comprise hardware and software including networking components, control systems, sensors, positioning systems, and wired/wireless connections that allow server(s) 106 to communicate with and control the scale system 102 in a variety of autonomous, semi-autonomous, or manual modes.

Server(s) 106, as described herein, may vary widely in configuration or capabilities but are comprised of at least a special-purpose digital computing device including at least one or more central processing units and memory. The server(s) 106 may also include one or more of mass storage devices, power supplies, wired or wireless network interfaces, input/output interfaces, and operating systems, such as Windows Server, Mac OS X, Unix, Linux, FreeBSD, or the like. In an example embodiment, server(s) 106 may include or have access to memory for storing instructions or applications for the performance of various functions and a corresponding processor for executing stored instructions or applications. For example, the memory may store an instance of the server(s) 106 configured to operate in accordance with the disclosed embodiments.

According to an embodiment, server(s) 106 may comprise cloud computing data centers configured to provide client devices with access to an application, service, or platform. For example, Software-as-a Service (“SaaS”) provides the capability to use a provider's applications running on a cloud infrastructure. The applications are accessible from various client devices through a thin client interface such as a web browser or an application. Cloud computing includes a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Server(s) 106 may connect to scale system 102 through communication interface 104 using a virtual scale and communicate operating instructions to the scale system 102 based on software-defined kiosk workflow and information stored in database 114. The scale management system may include a platform for creating and editing virtual kiosks that associate functionalities and workflow with scale system 102. The platform may include a web interface that can be accessed over network 108 to provide administrative capabilities to scale administrator computing device 110 to create and modify scales and their associated kiosks.

The virtual kiosks may be accessed by and rendered on user mobile device 112 through network 108 to utilize scale system 102. For example, a scale owner user (110) may sign on to server(s) 106 via a web portal to create and define a virtual scale.

A virtual scale may comprise a software representation of a physical scale, specifically, the virtual scale definition describes how the physical scale operates. The virtual scale includes a data connection to the physical scale and may obtain scale data from the physical scale. Virtual kiosks may correspond to a virtual scale, and a virtual scale can have one or more virtual kiosks connected to it. Users (112) can connect to a scale's different virtual kiosks, depending upon how they need to use the scale and the types of authorization they have been given.

Network 108 may be any suitable type of network allowing transport of data communications across thereof. The network 108 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from devices may be encrypted using, for example, the Advanced Encryption Standard (AES) with a 128, 192, or 256-bit key size, or any other encryption standard known in the art.

Scale administrator computing device 110 may comprise computing devices (e.g., desktop computers, laptops, personal digital assistants (PDA), cellular phones, smartphones, tablet computers, or any computing device having a central processing unit and memory unit capable of connecting to a network). User mobile device 112 may comprise computing devices and vary in terms of capabilities or features, for example, a cell phone, a tablet computer, a laptop, and in-dash car computer, or the like. The user mobile device 112 may comprise a web-enabled client device, which may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display.

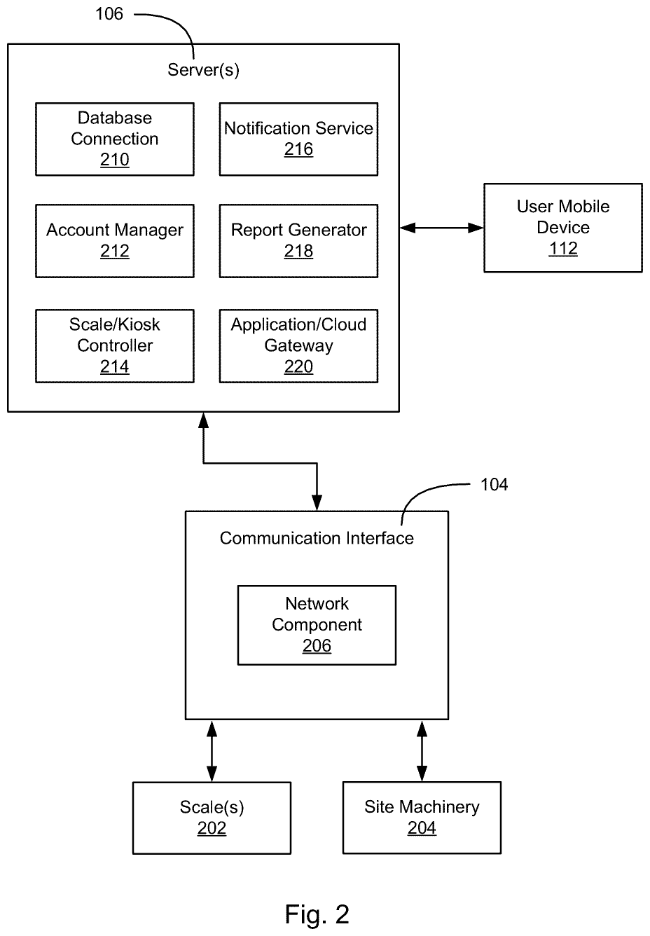

FIG. 2 presents a data flow diagram of a scale management system according to an embodiment of the present invention. A weighing site may include scale(s) 202 and site machinery 204. Scale(s) 202 may comprise one or more weighing apparatuses for measuring the weight of cargo. Site machinery 204 may comprise equipment or hardware that are used in conjunction with scale(s) 202 such as automated equipment, sensors, and cameras for loading/unload, scanning, and signaling. Scale(s) 202 and/or site machinery 204 that may be Internet protocol (IP)-enabled devices connected to the scale(s) 202, such as sensors that indicate if the cargo is on scale(s) 202, may be operable by via virtual scale and kiosk interfaces that are provided by server(s) 106 to user mobile device 112.

Server(s) 106 includes database connection 210, account manager 212, scale/kiosk controller 214, notification service 216, report generator 218, and application/cloud gateway 220. A virtual scale and kiosk may be retrieved by user mobile device 112 by logging in or accessing an account with account manager 212. Application/cloud gateway 220 may comprise an intermediary that allows communication between server(s) 106 and user mobile device 112. The application/cloud gateway 220 may provide high-level secure network system communication. For example, when user mobile device 112 requests access to resources of server(s) 106 such as files, Web pages and databases, the user mobile device 112 may first connect with a proxy server, which then establishes a connection with the main server. Account manager 212 may save and load virtual scales and kiosks through database connection 210.

Scale/kiosk controller 214 may define and associate user interface controls with physical features of scale(s) 202 and site machinery 204. The scale/kiosk controller 214 may communicate with scale(s) 202 and/or site machinery 204 through communication interface 104. Communication interface 104 includes network component 206. The network component 206 may comprise network-related devices (e.g., communication devices, routers (e.g., wireline or wireless routers), switches, etc.). In some implementations, one or more network-related devices of the network component 206 can be connected to or interfaced with scale(s) 202 and site machinery 204 to facilitate collecting data (e.g., industrial-automation-system-related data) from the scale(s) 202 and site machinery 204 or communicating information (e.g., control signals, parameter data, configuration data, etc.) to the scale(s) 202 and site machinery 204.

Account manager 212 may also facilitate billing and payment functions associated with the usage of scale(s) 202. Report generator 218 may generate reports of activity, billings, payments, maintenance, and errors. Notification service 216 may generate alerts or messages to user mobile device 112 and scale administrator computing device 110 to report tickets, invoices, confirmations, reminders, warnings, and other system reports.

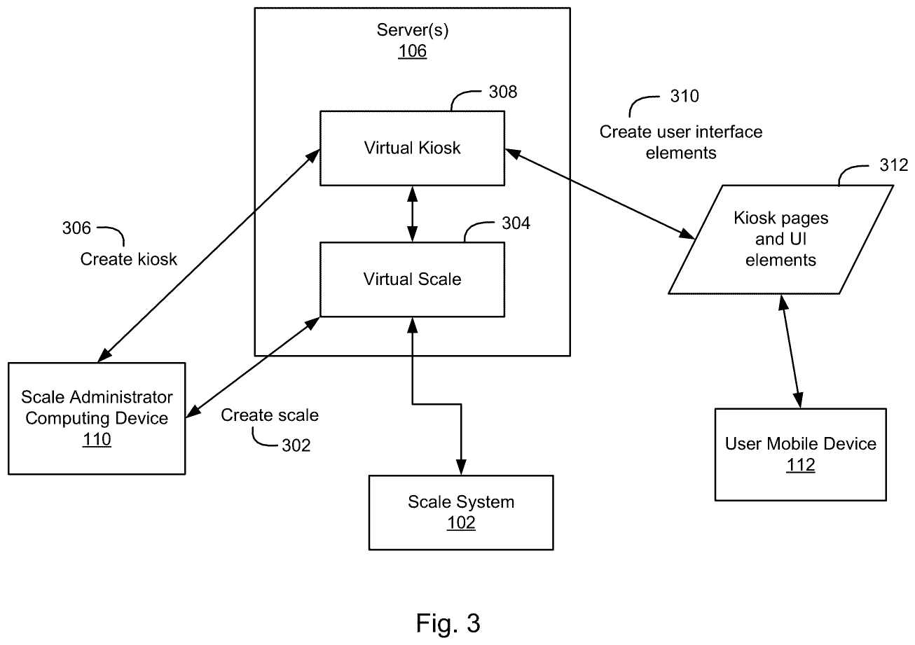

FIG. 3 presents a data flow diagram of a scale management system according to an embodiment of the present invention. A web interface may be provided by a scale management system on server(s) 106 for scale owners to create virtual scales and kiosks associated with the virtual scales. Virtual scale 304 may be created either manually or with the use of a template, or through an API.

A scale administrator computing device 110 may access the scale management system to initialize a process (302) for creating a virtual scale 304. Virtual scale 304 may comprise a representation of a physical scale at scale system 102 that is defined with certain attributes. Attributes of virtual scale 304 may comprise hardware specifications of the scale including make and model number, scale type such as a platform or a bucket scale, weighing capability, behavior of the scale, a service set identifier (SSID), and a port number. In one embodiment, an administrative user may add scale definitions to a database table of the system where users may be able to select from when creating their own user defined scales. Users may be able to filter available scales by physical scale type, such that only available scales of a selected type, for example platform or bucket scales, will be shown.

Virtual scale 304 may also be associated with a company, for example, by linking the virtual scale to the name of the company. Users including weighers, drivers, and administrators may be able to set a default scale to use for a given company. For example, within their user profile, users may select a given company from a list of companies with whom they are associated, view a list of platform or bucket scales associated with that company, and set a default scale for use with the given company. Users may view, edit, and remove a default scale by clicking a “remove Default Scale” button within their user profile. Virtual scale 304 and the virtual kiosk may be generated based on the set default scale. When a user is using their default scale, a message saying “Connect to <default-scale-name>” will be displayed. If the user does not want to use the displayed default scale, they may cancel the weighment workflow and initiate a new one. Otherwise, the user will connect to the default scale, receive a message asking, “Are you ready to weigh on <default-scale-name>?”, and proceed with the weighment workflow.

Virtual scale 304 may also be linked to the location of the company. The location may include data that contains the latitude and longitude of the scale's location. For example, user mobile device 112 using the scale management system to weigh cargo may be presented with a scale having a location nearest to a current location of user mobile device 112. According to one embodiment, the location of the company may also be linked to virtual scales for a plurality of locations for a pick-up and drop-off, e.g., the case of a haul-back job, where materials are picked up at one location, dropped at a second location, and then more material is picked up and brought back to either the original or a third location. The virtual scale 304 may also include a special code that an owner of the scale can specify to differentiate scales when multiple scales are present on a site. The special code can also be used to locate a scale, if for example, location services on user mobile device 112 is not available.

According to one embodiment, the location data of the scale may be used to create a geo-fence that specifies a distance that the user mobile device 112 can be away from the scale in order to make a valid connection. A pre-configured or user-specified distance and units of distance may be used to set the geo-fence. The default distance units may be configured for the country where the scale is located. If user mobile device 112 is within the geo-fence of a scale, the user mobile device 112 may attempt to connect to the scale and notify of a successful connection to the scale. Server(s) 106 or user mobile device 112 may also not allow or lockout a mobile device of a user (e.g., close enough to obviate the geo-fence) who is waiting on line to use a scale until the scale becomes available.

Virtual scale 304 may include a virtual locking functionality to ensure that only one user is able to communicate with a physical scale at a given time (e.g., weighing session). Specifically, when a current user is using a given physical scale and has successfully connected to it, other users may be blocked from also connecting to the given physical scale so that other users are unable to communicate with the given physical scale or obtain the weight of the cargo that is currently on the given physical scale. Other users waiting to use the given physical scale may be presented with a message, such as “scale is currently in use, please wait.” When the current user completes weighment, the given physical scale may be virtually unlocked so that a next user in a queue can connect to it. If a user currently using a scale doesn't complete their weighment and hence, unlock the scale, scale system 102 or virtual scale 304 may automatically time out the connection, after a predetermined amount of time (e.g., one minute) of being connected, to ensure that the scale isn't permanently locked.

The scale administrator computing device 110 may further initialize a process (306) to create virtual kiosk 308 using the scale management system. Virtual kiosk 308 can also be created through an API. Virtual kiosk 308 may include a workflow for display on a user mobile device 112. The create kiosk 306 process may include defining attributes of the virtual kiosk 308, such as pages, user interface (UI) elements, and billing options. Virtual kiosk 308 may be created manually or selected from pre-created templates. Virtual kiosk 308 and virtual scale 304 may be created and edited based on a user selection of a physical scale, for example a platform or a bucket scale.

Virtual kiosk 308 may be configured with “pay-to-weigh” and “company-owned” operating modes. A pay-to-weigh mode may allow scale-owners to charge users for each weighment, whereas the company-owned mode may not charge users. The company-owned mode allows the disclosed system to be used in cases where no payment is needed, such as in a plant where the aggregate producer owns the scale and doesn't charge for weighing cargo. A starting ticket value may be configured for generating custom ticket numbering sequences. The type of billing may also be configured for pay-to-weigh operation including billing to a customer's account or requesting a PIN associated with an account be specified, or billing to a credit card.

Weight units may also be specified to indicate units to be used for weighment, for example, tons, pounds, kilograms, and metric-tons. The disclosed system may be certified in accordance with the National Type Evaluation Program (“NTEP”) where weights that are collected, displayed, and processed by the disclosed system are considered “legal weights” and can be used as part of a financial transaction.

Weighing methods may also be configured for the virtual kiosk 308 including “tare-then-gross weight,” “gross-then-tare weight,” “gross-weight only,” “tare-weight only” (that allows for a unit of cargo's tare weight to be stored, independent of other workflows or weighments). In one embodiment, virtual kiosk 307 may comprise a “tare weight kiosk”, where a unit of cargo's tare weight is acquired and stored in the cloud for future use. The stored tare weight may expire, and a notification may be sent to a user associated with the tare weight before the tare weight expires. Workflows may be created through a computer scripting language (e.g., scale control and logistics environment).

Virtual kiosk 308 may also be created as a “payable kiosk” where a list of prices associated with a list of materials may be provided to a user along with the weight units for those materials, and have the system generate the price to be paid for receiving these materials, such as in a scrap metal yard.

User mobile device 112 may be used to connect to and/or interact with scale system 102 through virtual scale 304 and virtual kiosk 308. User mobile device 112 may connect to scale system 102 via virtual scale 304 that may be downloaded to user mobile device 112. Virtual scale 304 may include a SSID (or IP address, or public static IP) and a port number that a Transmission Control Protocol/Internet Protocol (TCP/IP) connection can be made to connect with scale system 102.

A location specified by a user or as determined by user mobile device 112 may be provided to virtual kiosk 308 to verify a correct virtual scale 304 to connect to. Virtual kiosk 308 may comprise an interface with virtual scale 304 that allows inter-process communications of data from a physical scale at scale system 102. Server(s) 106 may create (310) kiosk pages and user interface elements 312 for rendering on a screen of user mobile device 112 as defined by virtual kiosk 308. Kiosk pages and user interface elements 312 may include custom text fields, button, drop-down selectors for inputs that have a set of options to choose from.

In addition, the virtual scale 304 can be configured to allow a device to run in a “Tablet Kiosk Mode.” The “Tablet Kiosk Mode” may comprise an interface running on a site-provided client device, such as a tablet-kiosk for public use. The “Tablet Kiosk Mode” may allow the interface to execute the disclosed weighment workflows but allow a user to use a phone number or email address to operate the device, rather than logging in to a customer account. In the event that a client device loses connection to the server, a weighing session or activity may be saved on the client device and synchronize with the server when the connection is re-established.

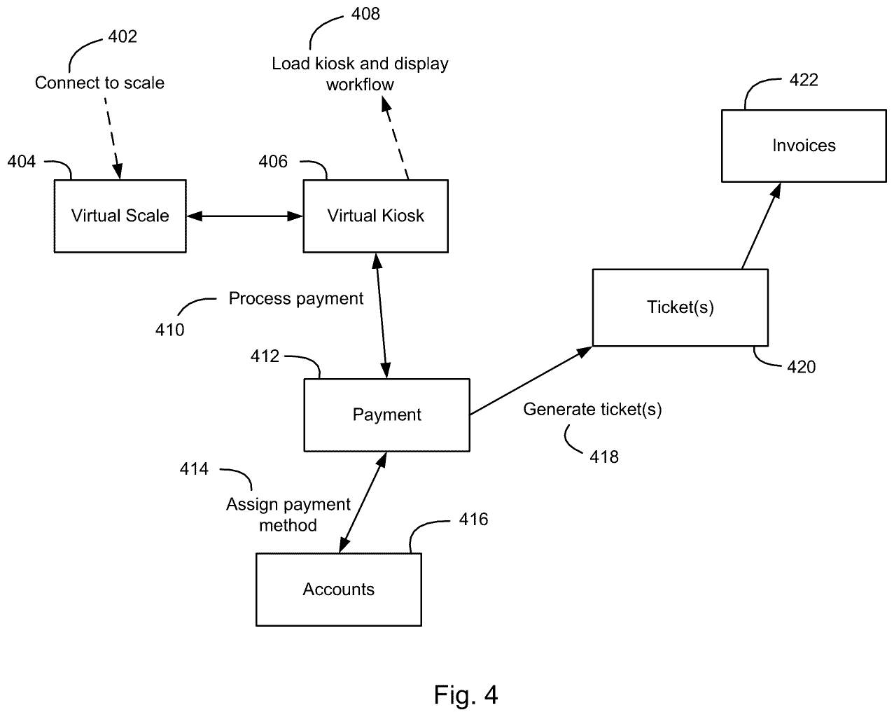

FIG. 4 presents a data flow diagram of a scale management system according to an embodiment of the present invention. A user from a device (such as user mobile device 112) may connect to virtual scale 404 via a TCP/IP connection (402). The virtual scale 404 may be automatically selected for a user on their device-based coordinates or location code. For example, user mobile device 112 may include a location services feature that can detect the location of the device using location data, such as GPS. A virtual kiosk 406 may be connected to or associated with virtual scale 404 and automatically downloaded to the user device to display workflow on the device (408).

Payments may be solicited where they are processed (410) by payment 412. Users may pay by methods such as credit card/debit or company account-based billing and/or account pin. Selected payment methods are assigned (414) to accounts 416. For example, a trucking company can have an account where the driver needs only to enter a PIN, rather than a credit card. Scale owners may create accounts for trucker users or owner operators. Accounts optionally have PINs for increased security and may be restricted to specific kiosks.

After payment is processed, ticket(s) are generated (418) and may be stored in a database. Ticket(s) 420 may comprise a digital ticket that is generated based on data from the scale and any information generated from virtual kiosk 406. Data on ticket(s) 420 may be displayed via the virtual kiosk. Invoices can be generated (422) when ticket(s) 420 are created.

In an embodiment, a user may choose to group several sub-weighments into one weighment workflow sequence. Based on a user request, ticket(s) 420 may comprise a master weigh ticket comprising an aggregate of all sub-tickets for all sub-weighments in a given weighment workflow sequence. For example, a user may weigh individual boxes of cargo one at a time on a platform scale, each weighment comprising a sub-weighment in a weighment workflow sequence, then aggregate all sub-weighments in the sequence into a master weigh ticket. Each sub-weighment corresponds to a sub-ticket comprising weighment data for a unit of cargo by the physical scale. In this manner, a platform scale may be used to individually weigh items as they are unloaded from a truck or picked up at a warehouse.

In another example, a user may weigh material to be loaded onto a truck using a bucket scale as part of a weighment workflow sequence, then aggregate all sub-weighments in the sequence into a master weigh ticket. Thus, a weight of a truck loaded with multiple units of cargo may be calculated. In this manner, a bucket scale attached to a bucket scooper may be used to weigh individual scoops of grain, dirt, or other loose material as they are dumped into a truck. The sum of all of the scoops is considered to be the weight loaded onto the truck.

In an exemplary weighment workflow sequence, a user may perform multiple weighments wherein each item of a load is individually weighed using a platform or bucket scale. For example, a load containing five items, each weighing 10 pounds, 20 pounds, 30 pounds, 40 pounds, and 50 pounds, respectively, may be weighed as five individual weighments producing five weigh tickets. A user may request a master weigh ticket comprising the sum of the five individual weighments, i.e., 150 pounds. The sub-weighments within a weighment workflow sequence may be performed during the course of one day, or they may span across several days.

An administrative user may create a master weigh ticket database table comprising fields such as master weigh ticket ID, master weigh ticket number, start date and start time for the first sub-ticket in a given weighment workflow sequence, and end date and end time of the last sub-ticket in the weighment workflow sequence. The master weigh ticket database table may further comprise a field indicating that the master weigh ticket and all sub-tickets within the weighment workflow sequence are void, a user ID identifying a voiding user, and a void date and void time indicating when the master weigh ticket and all sub-tickets within the weighment workflow sequence were voided. The master weigh ticket database table may further comprise fields indicating a total tare weight, i.e., the total tare weight for all sub-tickets in a weighment workflow sequence, a total gross weight, i.e., the total gross weight for all sub-tickets in a weighment workflow sequence, and a total net weight, i.e., the total net weight for all sub-tickets in a weighment workflow sequence. In the case of a gross weight only kiosk, a total tare weight comprises a sum of a stored tare for the box or bucket being weighed for each sub-weighment in a weighment workflow sequence. Server(s) 106 may be configured to create entries in the master weigh ticket database table for a weighment workflow sequence. Ticket(s) 402 generated as master weigh tickets may comprise information including any information in the master weigh ticket database table associated with a given weighment workflow sequence.

Users may submit a request for a weighment workflow sequence to be processed as a master weigh ticket via a “use master weigh tickets” or “create master weigh tickets” API comprising a user ID, company ID, scale ID, kiosk ID, and ticket object. If a given weighment is a first weighment in a weighment workflow sequence, an entry is be created in the master weigh ticket database table including a master weigh ticket ID. All sub-weighments in the weighment workflow sequence are assigned the same master weigh ticket ID. Thus, all sub-weighments in the weighment workflow sequence are associated with each other and may be grouped together when a master weigh ticket is generated upon completion of the weighment workflow sequence. A start date and start time of the first sub-weighment, as well as an end date and end time of the last sub-weighment are also saved in the entry. After each sub-weighment is completed, the screen interface, for example on a virtual kiosk displayed on web or user mobile device 112, will display a “Continue Workflow” button which will allow users to proceed to the next sub-weighment in the weighment workflow sequence. Alternatively, users may click a “Cancel” button at any time during the weighment workflow sequence to either cancel the current sub-ticket and continue to the next sub-weighment, or to cancel the current sub-ticket, finish weighing sub-tickets, and end the master weigh ticket workflow. The running total gross weight, total tare weight, and total net weight will be displayed at the end of each sub-ticket weighment in the sequence. These counters will be reset to zero when a new master weigh ticket is created for a new weighment workflow sequence.

Once a user initiates this type of weighment workflow sequence, the user will be unable to initiate another sequence until the current sequence is completed. Users may utilize a “finished weighing sub-tickets” API, or “Finished Weighing” button on the screen interface, to indicate that the last sub-ticket for a given master-ticket, identified by a master weigh ticket ID, is complete. A total gross weight, total tare weight, and total net weight for all sub-tickets in the completed weighment workflow sequence will be calculated and saved in the master weigh ticket database table. The end date and end time of the last sub-weighment are also saved in the table. A new master weigh ticket ID associated with a new weighment workflow sequence will be created the next time a user submits a request for a master weigh ticket via the “create master weigh tickets” API.

Users may utilize a “get master weigh tickets” API comprising a company ID, scale ID, kiosk ID, and start and end date and time-range filters to generate master weigh tickets from a virtual kiosk for a specified request. For example, if the date-range for the filter is Jun. 1, 2023 to Aug. 1, 2023, a master weigh ticket with dates ranging from Jun. 2, 2023 to Jun. 3, 2023, and all of its sub-tickets, would be included as a search result. On the other hand, a master weigh ticket with dates ranging from Jul. 31, 2023, to Aug. 2, 2023 and its sub-tickets would not be included as a search result under the specified date-range filter. Users may also sort master weigh tickets by date and time. As with filtering by date and time, sorting would also be based on the date and time of the master weigh ticket, i.e., the start date and time of the first sub-ticket and the end date and time of the last sub-ticket within the weighment workflow sequence, rather than the date and time of individual sub-tickets included under a master weigh ticket.

In an embodiment, the screen interface will display a visual indication that a ticket is a master weigh ticket. A “get sub-tickets by master weigh tickets” API, or “Show Sub-Tickets”button on the screen interface, may be utilized to get a paginated list of all sub-tickets associated with a given master weigh ticket ID. Users may also click on a master weigh ticket on the screen interface to show a list of sub-tickets associated with the master weigh ticket in a separate window.

Users may void a master weigh ticket using a “void master weigh ticket” API, or “Void” button on the screen interface, that voids a master weigh ticket and all sub-tickets associated with the master weigh ticket ID. Clicking the “Void” button will cause a warning message to be shown saying, for example, “Voiding a master weigh ticket will result in voiding all of its sub-tickets. Please confirm this action.” A voided master weigh ticket would comprise a visual indication that the master weigh ticket is void, the date and time when the master weigh ticket was voided, and information identifying the voiding user, such as a user ID.

When voiding a weigh ticket that has a financial transaction associated with it, e.g., users paying to dump materials at a landfill or users being paid for “peddling” scrap materials at a scrap yard, the amount of the financial transaction and any payment processing fees are reversed. As such, all parties are made whole upon voiding a weigh ticket, save for any transaction fees accrued for the act of voiding the weigh ticket itself.

Scale owners may determine whether the users or the owners themselves are responsible for covering any payment processing fees on an account-by-account basis. Upon voiding a weigh ticket, users who were responsible for paying any processing fees are automatically refunded such fees to their original form of payment, e.g., credited to their credit card or deposited into their bank account. Similarly, scale owners who were responsible for any processing fees are automatically refunded such fees, either to their credit card or bank account, when a weigh ticket is voided.

Scale owners may also determine whether the users or the owners themselves are responsible for covering fees accrued for voiding a weigh ticket. As with payment processing fees, responsibility for paying voiding ticket fees may be configured on an account-by-account basis. Unlike payment processing fees, voiding ticket fees are not refunded or reversed upon voiding the weigh ticket.

Users may create and define virtual scales by, for example, signing on to a web portal of a scale management system. A virtual scale may comprise a software representation of a physical scale, specifically, the virtual scale definition describes how the scale operates. The user may create, remove, edit, and view virtual scales. Virtual scales may comprise a digital analog corresponding to a physical scale.

Any one of the created virtual scales may be selected for viewing of scale information and details. A scale view displays a location of a physical scale (e.g., map view including address, coordinates, and location code) and scale information that was provided in creating the virtual scale. The scale view also allows the user to modify the scale (information) or duplicate the virtual scale to create another virtual scale entry.

The scale view further includes one or more virtual kiosks connected to the virtual scale. The scale view includes an option to view, create, and remove kiosks for the virtual scale. A virtual kiosk may be created to electronically document the use of a scale, for example, to accept credit card payments or account billing for pay to weigh scales. A virtual kiosk may also be configured to record items such as the material being weighed. Multiple kiosks may be created for a scale. Users may connect to a scale's different virtual kiosks, depending upon how they need to use the scale and the types of authorization they have been given.

Pages of a kiosk may define types of data that are solicited by the kiosk. An order of which pages presented by the kiosk may also be configured. For example, to customize the order of kiosk pages, an attribute box (e.g., “MATERIAL DESTINATION,” INSURANCE PROVIDER,” OR TRUCK INFORMATION”) may be dragged and rearranged in a desired order. Pages may contain a title, description, a UI element type, and UI element attributes. A UI element may be used to define a predefined list of inputs that may be selected from, e.g., text-fields, buttons, and drop-down selectors.

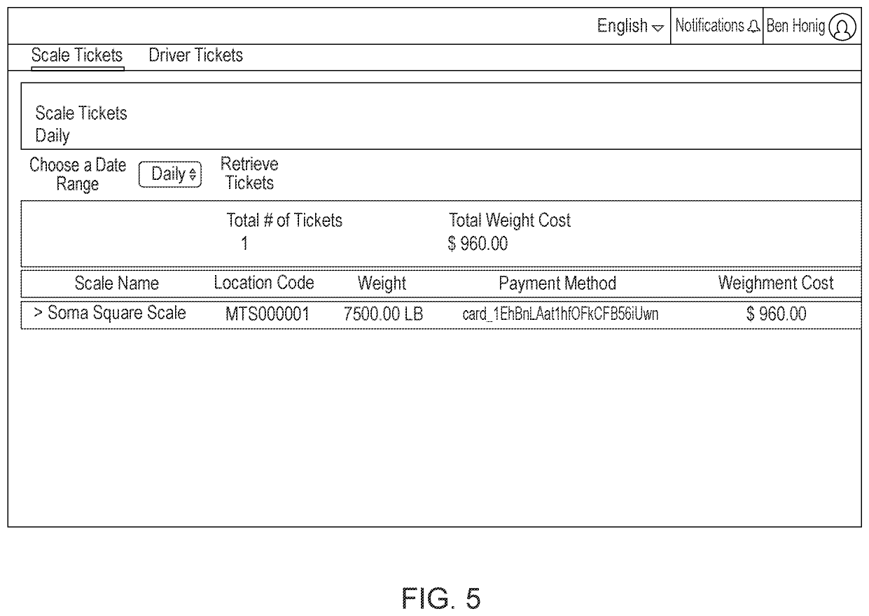

FIG. 5 presents an exemplary tickets interface according to one embodiment of the present invention. The administrative user may be able to view scale tickets and driver tickets produced by the scale management system from the operation of the kiosk and scales. Tickets may be retrieved for any period, e.g., daily, weekly, monthly, annually, etc. A ticket may include information, such as scale name, location code, weight, payment method, and weighment cost.

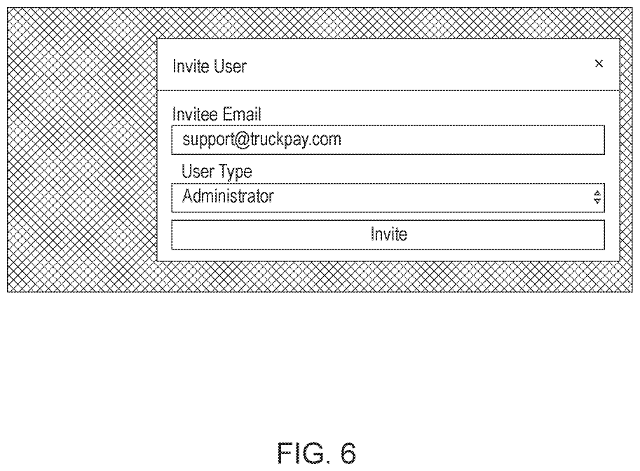

The disclosed scale management system may be a highly secured system with role-based application entitlement. The administrator user may be allowed to create user access to scale management system, as illustrated in FIG. 6. The ability to create virtual scales/kiosks and authorize invoice payments may be limited to administrators, whereas other users may be limited to accessing the virtual kiosk/scales to weigh their cargo. In an embodiment, a user may be invited to access the scale management system under the role of a weigher. For example, a weigher may use the scale management system to weigh cargo to be loaded onto a truck. In some embodiments, a user may be invited under the role of a driver using a truck scale as disclosed in U.S. patent application Ser. No. 18/219,493, owned by TruckPay Inc., the assignee of the present application. An existing user may change their role to that of a weigher, a driver, or vice versa. Each of the roles of user, weigher, and driver have the same permissions within the scale management system, i.e., to access a virtual kiosk/scale to weigh cargo.

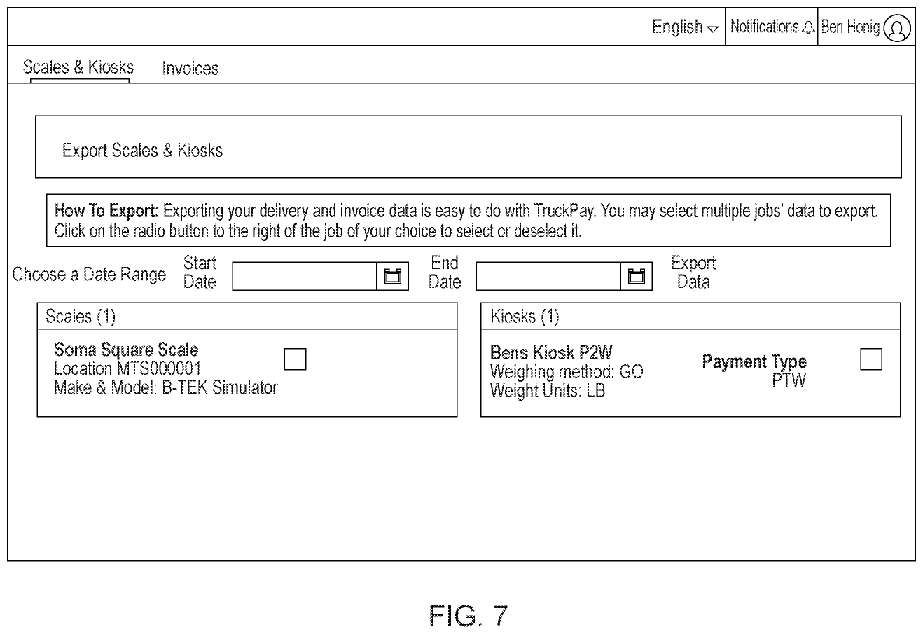

FIG. 7 presents an exemplary interface for exporting weighing and invoice data, e.g., in the form of weigh tickets and invoices from the scales and kiosks according to an embodiment of the present invention. The interface may allow for selection of particular weigh tickets and invoice data to export, such as from particular scales or kiosks. Scale and kiosk data may be exported in file formats, such as Portable Document Format (PDF), spreadsheet (e.g., Excel), and Comma-Separated Values (CSV). Weighments and invoices may also be exported to other upstream or downstream enterprise resource planning (ERP) systems, such as enterprise system software from SAP, Sage or another vendor, via an API.

For PDF files, each attribute of a ticket is displayed in a separate row. In the case of a master weigh ticket/sub-ticket sequence, the first page of the PDF is the master weigh ticket. The title of the first page will be “Master Weigh Ticket <z>,” where <z> is the master weigh ticket number, alongside an indication of the number of sub-tickets within the sequence. A start date, start time, end date, end time, total tare weight, total gross weight, and total net weight will also be shown. Each sub-ticket will be shown on successive pages, such that the title of each sub-ticket page will be “Sub-Ticket <x> of <y> for Master Weigh Ticket <z>,” where <x> is the number of a given sub-ticket in a sequence, <y> is the total number of sub-tickets in the sequence, and <z> is the master weigh ticket number. For example, if there are 20 sub-tickets for this master weigh ticket, the PDF export would contain twenty (20) pages following the master weigh ticket page. If a user has specified a company letterhead and/or terms and conditions for this kiosk, then the company letterhead will be shown at the top of each page in the PDF and the terms and conditions will be placed as the last pages.

For EXCEL and CSV exports, the first column to the right of the ticket attributes will display a “Master Weigh Ticket <z>,” where <z> is the master weigh ticket number. Subsequent columns will display “Sub-Ticket <x>,” where <x> is the number of a given sub-ticket in a weighment workflow sequence, e.g., “Sub-Ticket 1,” “Sub-Ticket 2,” etc. The tare, gross, and net weight attributes for the master weigh ticket will comprise the aggregated values for each weight.

When using a scale configured with the scale management system, a user may place a unit of cargo on the scale and tap a “connect to scale” button on an application executing a virtual kiosk on a mobile device to connect to a scale. For example, the user or mobile device of the user may specify a location to locate a nearest scale and initiate a workflow for weighing via a virtual kiosk. Scale location codes may be employed when pick-ups or deliveries are made to help locate a scale, if for example, location services aren't turned on.

The virtual kiosk can be one of many, or a same virtual kiosk used for a plurality of users at a scale system or a particular scale. The virtual kiosk may connect to the scale via an SSID (or IP address, or static IP address) and port number. Upon weighing in, the weight is displayed on the user's mobile device. If the user has not enabled data location services on the mobile device, then a location code displayed at the site may be inputted to tell the server the location. This may enable the mobile device to automatically connect to the scale.

Once connected to the scale, the application may download an appropriate virtual kiosk for the user. The application may then build and render custom views based on the parameters from the pages defined in the virtual kiosk. The application may then guide the user through the customized workflow of the virtual kiosk, including entering user information, weighing in, completing payment and review.

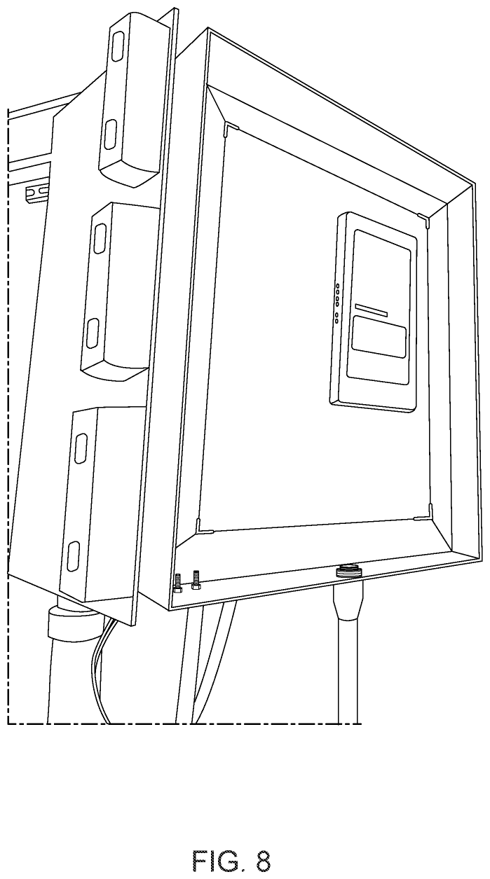

FIG. 8 presents a tablet kiosk device according to an embodiment of the present invention. A tablet kiosk device may comprise a site-provided client device that allows a driver to use the disclosed weighment workflows. According to one embodiment, a site may comprise a plurality of tablet kiosk devices allowing for a plurality of users to execute weighment workflows simultaneously. Virtual tablet kiosks may execute on the tablet kiosk devices to enable the public use of weighment workflows via a single login mode user using messaging communications, such as email and/or SMS to send weigh tickets to the user. The virtual tablet kiosk may also be configured to operate in a “user login” mode where the user may login with a user account as disclosed above.

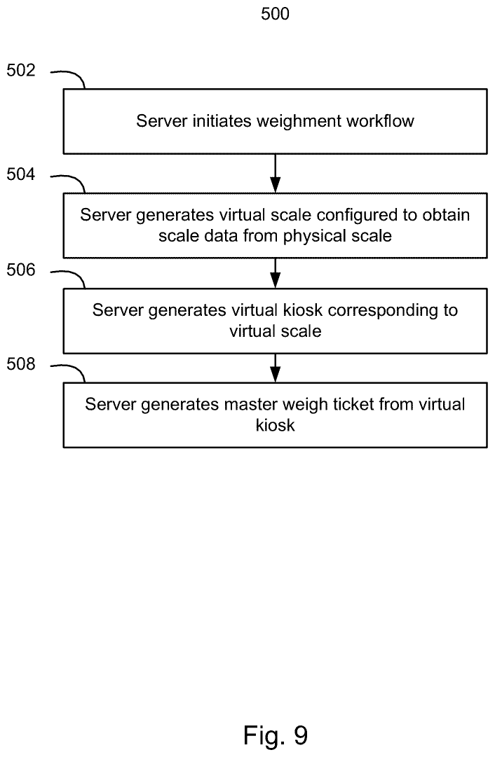

With reference to FIG. 9, a process 500 of using the scale management system will now be described. The process 500 of FIG. 9 comprises steps 502-508.

At step 502, server 106 initiates a weighment workflow for cargo carried by a first vehicle, the cargo comprising one or more units.

At step 504, server 106 generates a virtual scale configured to obtain scale data from a physical scale, e.g., during the create kiosk 306 process described above. The physical scale comprises a scale designed to weigh individual cargo units.

At step 506, server 106 generates a virtual kiosk corresponding to the virtual scale, e.g., during the create kiosk 306 process described above. The virtual kiosk is configured for use during weighments of the one or more units in the cargo on the physical scale.

At step 508, server 106 generates a master weigh ticket from the virtual kiosk comprising weighment data for the cargo, the weighment data comprising first weighment data for the one or more units in the cargo and second weighment data for a total weighment of the cargo by the physical scale.

The particular processing operations and other system functionality described in conjunction with the flow diagram of FIG. 9 are presented by way of illustrative example only and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement the disclosed embodiments.

Functionality such as that described in conjunction with the process of FIG. 9 may be implemented at least in part in the form of one or more software programs stored in memory and executed by a processor of a processing device such as a computer or server. As will be described herein, a memory or other storage device having executable program code of one or more software programs embodied therein is an example of what is more generally referred to herein as a “processor-readable storage medium.”

FIGS. 1 through 9 are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

It should be understood that the various aspects of the embodiments could be implemented in hardware, firmware, software, or combinations thereof. In such embodiments, the various components and/or steps would be implemented in hardware, firmware, and/or software to perform the functions of the disclosed embodiments. That is, the same piece or different pieces of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A scale management system comprising a processor coupled to memory, the processor being configured to:
initiate a weighment workflow for cargo carried by a first vehicle, the cargo comprising one or more units;
generate a virtual scale configured to obtain scale data from a physical scale, the physical scale comprising a scale designed to weigh individual cargo units and the virtual scale comprising a software representation of the physical scale, wherein hardware specifications of the physical scale are defined via the virtual scale;
generate a virtual kiosk corresponding to the virtual scale, the virtual kiosk being configured for use during weighments of the one or more units in the cargo on the physical scale; and
generate a master weigh ticket from the virtual kiosk comprising weighment data for the cargo, the weighment data comprising first weighment data for the one or more units in the cargo and second weighment data for a total weighment of the cargo by the physical scale.

2. The scale management system of claim 1, wherein the physical scale comprises a platform or bucket scale.

3. The scale management system of claim 1, wherein the virtual kiosk is configured for access by a user on a mobile device.

4. The scale management system of claim 1, wherein the processor is further configured to edit the virtual scale and the virtual kiosk based at least in part on a user selection of a physical scale.

5. The scale management system of claim 1, wherein the processor is further configured to filter available scales based at least in part on a user selection of a physical scale.

6. The scale management system of claim 1, wherein the processor is further configured to set a default scale based at least in part on a user selection of a default scale.

7. The scale management system of claim 6, wherein the processor is further configured to generate the virtual scale and the virtual kiosk based at least in part on the set default scale.

8. The scale management system of claim 1, wherein the total weighment data of the cargo comprises a total gross weight and a total net weight.

9. The scale management system of claim 1, wherein the master weigh ticket further comprises a weigh ticket number, a start date, a start time, an end date, an end time, an indication that the master weigh ticket is void, a void date, a void time, and information identifying a voiding user.

10. The scale management system of claim 1, wherein the processor is further configured to generate a sub-weigh ticket from the virtual kiosk, the sub-weigh ticket comprising weighment data for a unit of cargo by the physical scale.

11. A method executed by a hardware processor, the method comprising:
initiating a weighment workflow for cargo carried by a first vehicle, the cargo comprising one or more units;
generating a virtual scale configured to obtain scale data from a physical scale, the physical scale comprising a scale designed to weigh individual cargo units and the virtual scale comprising a software representation of the physical scale, wherein hardware specifications of the physical scale are defined via the virtual scale;
generating a virtual kiosk corresponding to the virtual scale, the virtual kiosk being configured for use during weighments of the one or more units in the cargo on the physical scale; and
generating a master weigh ticket from the virtual kiosk comprising weighment data for the cargo, the weighment data comprising first weighment data for the one or more units in the cargo and second weighment data for a total weighment of the cargo by the physical scale.

12. The method of claim 11, wherein the step of generating the virtual scale configured to obtain scale data from the physical scale comprises a physical scale comprising a platform or bucket scale.

13. The method of claim 11, wherein the step of generating the virtual kiosk corresponding to the virtual scale comprises generating a virtual kiosk configured for access by a user on a mobile device.

14. The method of claim 11, wherein the method further comprises editing the virtual scale and the virtual kiosk based at least in part on a user selection of a physical scale.

15. The method of claim 11, wherein the method further comprises filtering available scales based at least in part on a user selection of a physical scale.

16. The method of claim 11, wherein the method further comprises setting a default scale based at least in part on a user selection of a default scale.

17. The method of claim 11, wherein the step of generating the master weigh ticket from the virtual kiosk comprising weighment data for the cargo comprises generating a master weigh ticket from the virtual kiosk comprising a total gross weight and a total net weight.

18. The method of claim 11, wherein the step of generating the master weigh ticket from the virtual kiosk further comprises generating a master weigh ticket comprising a weigh ticket number, a start date, a start time, an end date, an end time, an indication that the weigh ticket is void, a void date, a void time, and information identifying a voiding user.

19. The method of claim 11, wherein the method further comprises generating a sub-weigh ticket from the virtual kiosk, the sub-weigh ticket comprising weighment data for a unit of cargo by the physical scale.

20. A non-transitory computer readable medium comprising instructions that, when executed by at least one processor, cause the at least one processor to:
initiate a weighment workflow for cargo carried by a first vehicle, the cargo comprising one or more units;
generate a virtual scale configured to obtain scale data from a physical scale, the physical scale comprising a scale designed to weigh individual cargo units and the virtual scale comprising a software representation of the physical scale, wherein hardware specifications of the physical scale are defined via the virtual scale;
generate a virtual kiosk corresponding to the virtual scale, the virtual kiosk being configured for use during weighments of the one or more units in the cargo on the physical scale; and
generate a master weigh ticket from the virtual kiosk comprising weighment data for the cargo, the weighment data comprising first weighment data for the one or more units in the cargo and second weighment data for a total weighment of the cargo by the physical scale.
